(19) United States
(12) Patent Application Publication
(10) Pub. No.: US 2026/0131868 A1
(43) Pub. Date: May 14, 2026

(54) DRIVE SYSTEM FOR AN ELECTRIC BICYCLE WITH STATE IDENTIFICATION FOR A FREEWHEEL DURING A GEAR-SHIFTING PROCESS, AND OPERATING METHOD

(71) Applicant: BROSE ANTRIEBSTECHNIK GMBH & CO. KOMMANDITGESELLSCHAFT, BERLIN, Berlin (DE)

(72) Inventors: Jörg HERING, Fredersdorf (DE); Heath LEE, Berlin (DE)

(21) Appl. No.: 18/877,681

(22) PCT Filed: Jun. 19, 2023
(86) PCT No.: PCT/EP2023/066448

§ 371 Date: Dec. 20, 2024

(30) Foreign Application Priority Data
Jun. 24, 2022 (DE) 10 2022 206 382.1

(51) Int. Cl. B62M 6/50; B62J 45/20; B62M 9/06

(52) U.S. Cl. CPC B62M 6/50; B62J 45/20; B62M 9/06

(57) ABSTRACT

The proposed solution relates in particular to a drive system for an electric bicycle, comprising a drive train having at least one electric drive motor for applying a drive force for driving a wheel of the electric bicycle, a gear shifting device for changing a transmission ratio between the drive train and the wheel to be driven, and an electronic control unit for controlling the at least one drive motor and the gear shifting device. A freewheel is provided on the wheel to be driven, which freewheel, in a transmitting state, transmits drive force generated by the at least one drive motor to the wheel, while in an uncoupling state of the freewheel the drive train is uncoupled from the wheel.

### CROSS REFERENCE TO RELATED APPLICATIONS

The present application is a U.S. National Phase of International Application No. PCT/EP2023/066448 entitled “DRIVE SYSTEM FOR AN ELECTRIC BICYCLE WITH STATE DETECTION FOR A FREEWHEEL DURING A GEAR CHANGING OPERATION, AND OPERATING METHOD,” and filed on Jun. 19, 2023. International Application No. PCT/EP 2023/066448 claims priority to German Patent Application No. 10 2022 206 382.1 filed on Jun. 24, 2022. The entire contents of each of the above-listed applications are hereby incorporated by reference for all purposes.

### BACKGROUND

The proposed solution relates in particular to a drive system for an electric bicycle.

It is known, on an electric bicycle, thus also on what is known as an e-bike or Pedelec, to use at least one electric motor in combination with a transmission device, e.g. comprising a planetary gear stage, in order to provide motorized assistance when riding the electric bicycle. In this case, a corresponding drive system comprises a drive shaft (typically also referred to as a bottom bracket shaft), via which a drive torque generated by a rider of the electric bicycle can be introduced, and on which pedals are provided for this purpose. In addition to a first drive torque introduced on the drive shaft in a manner operated by muscle power, a second drive torque can be provided operated by external force, e.g. with the aid of an electric drive motor. The at least one drive motor and the drive shaft are coupled together via the transmission device, such that a torque can be transmitted to a wheel, usually a rear wheel of the electric bicycle, via a drive shaft to be coupled to a wheel of the electric bicycle, which torque can be traced back to the first and second drive torque.

A transmission ratio between the drive train, comprising the at least one electric drive motor, and the wheel to be driven, can be changed via an electronically controllable gear-shifting device, as is known e.g. from DE 10 2020 001 016 A1. In this case, there is the fundamental difficulty that on the one hand an automatic gear-shifting process for changing the transmission ratio should take place only if no drive force is applied by muscle power, via a pedal movement. However, on the other hand the gear-shifting process should take place in an electromotively controlled manner via a brief forward movement of a force transmission member, typically a chain, via which the drive train is coupled to the wheel to be driven. For this purpose, the drive motor is operated at a defined motor speed, without the wheel being driven by the drive motor. Accordingly, a freewheel is provided on the wheel to be driven, which freewheel is intended to not be present in a transmitting state, for the gear-shifting process, in which state a drive force generated by the at least one drive motor is transmitted to the wheel to be driven. Rather, the freewheel is intended to remain in an uncoupling state, in which the drive train is uncoupled from the wheel, such that a motor-generated drive force is not transmitted to the wheel. Consequently, during the gear-shifting process the freewheel should remain open and thus in the uncoupling state. In this case, the freewheel remains open, from a motor perspective, for example in that a resulting speed of a sprocket driven by a force transmission member is sufficiently lower than the speed of the rear wheel.

A direct sensor-based detection of the state of the freewheel during the gear-shifting process is comparatively complex. In principle, simple regulation of the motor speed and the speed of a rear wheel sprocket is also conceivable, in which a limited motor speed is specified which is significantly reduced compared with a speed calculated from the rear wheel speed and the gear ratio, for example by 50%. However, in the case of an error in the measurement of the rear wheel speed by a speed sensor, or in the case of an incorrectly assumed gear ratio, in such an error case too great a motor speed for the gear-shifting process may arise. It is alternatively conceivable to provide an additional speed sensor for the wheel to be driven, in order to ensure that during the gear-shifting process (also in the event of an error) no acceleration of the wheel occurs. However, an additional speed sensor of this kind, which may have to be provided to a speed sensor provided in any case for determining the transmission ratio, is associated with not insignificant additional costs.

### SUMMARY

Against this background, the proposed solution addresses the problem of providing a drive system having the possibility of an electronically controlled change of a transmission ratio, in which a gear-shifting process for changing the transmission ratio can be carried out and monitored in a simple manner.

For this purpose, a drive system for an electric bicycle is proposed, in which the electronic control unit of the drive system is configured, for changing the transmission ratio, to perform a gear-shifting process in which a speed of the at least one drive motor is specified, in particular regulated, by the electronic control unit, and the at least one drive motor is operable via the electronic control unit with a variable motor current. The electronic control unit is furthermore configured to terminate the gear-shifting process when a termination criterion indicating a transmitting state of the freewheel is present, and, for detecting the presence of the termination criterion, to evaluate a curve of the speed and/or a curve of the motor current of the at least one drive motor.

The basic concept of the proposed solution is therefore that of terminating an electronically controlled gear-shifting process, which is to be performed in the case of a moving electric bicycle without pedal movement, for changing a transmission ratio between the drive train and the driveable wheel, when the freewheel of the wheel is closed and thus a drive force of the drive motor is transmitted to the wheel and would thus lead to an undesired acceleration of the wheel. In this case, the state of the freewheel is detected indirectly, specifically via the curve of the (motor) speed and/or the curve of the motor current of the at least one drive motor, and thus without additional sensors having to be provided for this purpose. Therefore, in the proposed solution, after triggering a gear-shifting process, the state of the freewheel is concluded on the basis of a (temporal) curve of the speed and/or a (temporal) curve of the motor current of the at least one drive motor, and whether the already triggered gear-shifting process is either carried out or completed, or terminated, depends on said state.

In this case, the gear-shifting process can in principle be triggered automatically, in a manner known per se. In this case, the triggering and thus the start of the gear-shifting process are for example dependent, in a corresponding variant, on no drive force currently being actuated by muscle power, and therefore pedals of the electric bicycle attached to a bottom bracket shaft in a rotationally fixed manner not being rotated. The target speed of the drive motor to be specified for performing the gear-shifting process is then calculated and specified by the electronic control unit on the basis of a travel speed (for example determined via a sensor signal of a speed sensor provided on the wheel to be driven) and a currently set transmission ratio between the drive train and the wheel to be driven. The electronic control unit can therefore in particular be configured to determine a target speed (to which the at least one drive motor is to be accelerated for the gear-shifting process) on the basis of a sensor signal representative of a current travel speed of the electric bicycle and a currently (i.e. before the start of the gear-shifting process) set transmission ratio. After the start of the gear-shifting process, the drive motor should merely cause a force transmission member of the drive motor to move when the freewheel is open, such that at least one gear can be changed in a manner electronically controlled by the gear-shifting device, for example by actuating a derailleur of the gear-shifting device. When the freewheel is closed, the gear-shifting process should be automatically terminated.

In a variant, the electronic control unit is configured to detect the presence of the termination criterion (and thus a possibly closed freewheel) on the basis of the curve of the speed and/or the curve of the motor current of the at least one drive motor. This in particular includes the presence of the termination criterion being detected exclusively on the basis of one or more of the mentioned curves. For example, the electronic control unit is configured, for this purpose, to detect the presence of the termination criterion solely on the basis of the curve of the motor current or in combination with the curve of the speed of the at least one drive motor. It was thus identified that it is possible to conclude the state of a freewheel on the driveable wheel on the basis of the curve of the motor current alone or in combination with a detected curve of the (motor) speed. Thus, via evaluation logics, for example implemented via software in the control electronics, it is possible to conclude, on the basis of a detected curve, whether the freewheel is open or closed, without additional sensors being required on the freewheel itself for this purpose.

For example, it is provided that for the uncoupling state of the freewheel and thus for an open state of the freewheel during the gear-shifting process at least one reference speed curve for a temporal development of the speed and/or at least one reference current value curve for a temporal development of the motor current of the at least one drive motor are stored in a memory of the electronic control unit. The electronic control unit can then be configured, in the case of a deviation, that exceeds a tolerance threshold, of one or more detected measured values relative to the reference speed curve and/or the reference current value curve, to detect the presence of the termination criterion. Thus, a characteristic reference speed curve and/or a characteristic reference current value curve result if, during a gear-shifting process, the freewheel is open and remains open and is therefore in an uncoupling state. If, during the gear-shifting process, a deviation from one or more of these stored curves is detected, it can be concluded that the freewheel is not (any longer) open, but rather is closed.

In order to detect whether the termination criterion is present and thus the freewheel may be present in a transmitting state or has switched into such a transmitting state, the electronic control unit can for example be configured to check, during the gear-shifting process, whether
the speed of the drive motor increases with specification of a motor current increasing up to a maximum current value until a specified target speed is reached, and the motor current falls when the target speed is reached and maintained (first test scenario), or
the speed of the drive motor increases with specification of a motor current increasing up to a current target value, up to the target speed, and the target speed is maintained, retaining the current target value that is below the maximum current value (second test scenario).

The first above-mentioned test corresponds to a test scenario in which it is checked, with the aid of the electronic control unit, whether the motor speed and motor current develop as specified during an acceleration phase of the drive motor for the gear-shifting process and in a subsequent gear-shifting phase, and thus an open freewheel can be assumed. Thus, the increase in the motor current and a subsequent fall to below a specified maximum current value, while at the same time the speed of the drive motor is accelerated up to a desired target speed and maintained, makes it possible to conclude that the freewheel is and remains open. When the target speed is maintained, a gear-shifting phase can then be concluded, while the transmission ratio is changed by the gear-shifting device.

In the case of the test discussed above, for the presence of a termination criterion, it is assumed, according to a second test scenario, that in an acceleration phase the speed initially increases up to the target speed without the motor current reaching the maximum current value, but rather increases only up to a current target value below the maximum current value. The target speed of the drive motor is thus maintained when the freewheel is open, while the motor current still remains at the current target value. If corresponding curves of the motor current and the speed of the at least one drive motor are detected, an open freewheel is concluded and the gear-shifting process is completed without termination.

In principle, a maximum current value discussed above can be a limit value stored in the electronic control unit, which limit value can be specified, by a regulation implemented using the control unit, as the maximum value for the motor current for accelerating the at least one drive motor to the target speed. The maximum current value can thus be an underlying current target value which is limited to a comparatively low value which is sufficient for adequately accelerating the drive motor in freewheel operation. Consequently, upon acceleration of the drive motor, the regulation will, within limits, (be able to) request at most a maximum current corresponding to the maximum current value.

If the electronic control unit performs a test, in a corresponding variant, of whether the motor current and/or speed of the at least one drive motor develops as intended during the gear-shifting process, it is possible to conclude, on the basis of deviations of corresponding reference curves, that the freewheel is closed, and thus the termination criterion is present. Thus, for example closing of the freewheel after the target speed is reached, and a previous drop in the motor current leads, in the motor current, to a renewed increase in the direction of the maximum current value. After completion of the acceleration phase, again a temporary drop in the rotation curve can be observed when the freewheel is closed. An evaluation logics of the electronic control unit is consequently configured here to detect, on the basis of deviations from stored reference curves, that a change from an uncoupling state to a transmitting state has taken place at the freewheel of the driveable wheel, and thus a transmission of a drive torque from the drive motor to the wheel to be driven, which is undesired during the gear-shifting process, takes place.

Alternatively or in addition, for detecting whether the termination criterion is present (i.e. for detecting the presence of the termination criterion) the electronic control unit can be configured for checking, during the gear-shifting process, whether the speed of the at least one drive motor reaches a specified target speed within a predefined test period. This includes a test as to whether an intended acceleration of the drive motor is achieved, and/or the speed of the at least one drive motor—i.e. for example of a rotor of the drive motor-cannot be increased further up to the target speed. If this is the case and can be detected electronically on the basis of the curve of the motor speed, it is to be assumed that the freewheel is closed and correspondingly the drive force generated by the drive motor is transmitted to the wheel to be driven. The termination criterion is therefore met and the gear-shifting process is terminated.

In principle, a termination of the gear-shifting process by the electronic control unit can include a reduction of the speed of the at least one drive motor to a termination value. Alternatively, in the case of a termination of the gear-shifting process the at least one drive motor can be actuated to change into an error state or deactivated and thus switched off.

The proposed solution furthermore also includes an electric bicycle comprising a variant of a proposed drive system.

Furthermore, the proposed solution includes a method for operating a drive system on an electric bicycle. A drive system of this kind for an electric bicycle comprises at least one drive train having at least one electric drive motor for applying a drive force for driving a wheel of the electric bicycle, and an (electronically controllable) gear-shifting device for changing a transmission ratio between the drive train and the wheel to be driven. A freewheel is provided on the wheel to be driven, which freewheel, in a transmitting state, transmits a drive force generated by the at least one drive motor to the wheel, while in an uncoupling state of the freewheel the drive train is uncoupled from the wheel. For changing the transmission ratio a gear-shifting process is performed in which, in an electronically controlled manner, a speed of the at least one drive motor is specified, in particular regulated, and the at least one drive motor is operated with a variable motor current. The gear-shifting process is terminated when a termination criterion indicating the transmitting state of the freewheel is present, wherein for detecting the presence of the termination criterion a curve of the speed and/or a curve of the motor current of the at least one drive motor is evaluated.

A proposed operating method can in particular be carried out using a variant of a proposed drive system. Features and advantages of a variant of a proposed drive system set out above and in the following therefore also apply for a variant of a proposed operating method, and vice versa.

### BRIEF DESCRIPTION OF THE FIGURES

The accompanying figures illustrate possible embodiments of the proposed solution by way of example.

FIG. 1 shows an electric bicycle comprising a variant of a proposed drive system.

FIG. 2 shows a reference value curve for a motor current during an electronically controlled gear-shifting process using the drive system of FIG. 1.

FIG. 3 shows further reference curves for the motor current and motor speed during a gear-shifting process.

FIG. 4 is a flow diagram for a variant of a proposed operating method.

### DETAILED DESCRIPTION

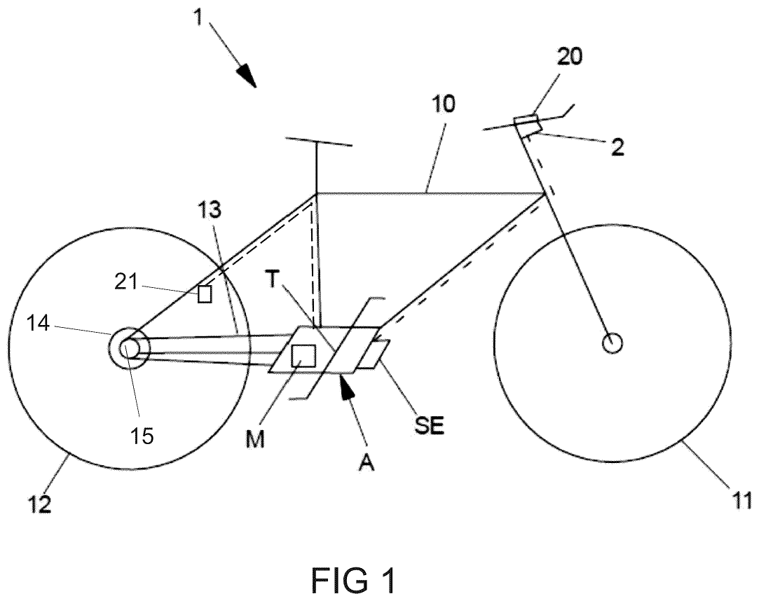

FIG. 1 shows, by way of example, an electric bicycle 1 comprising a frame 10 on which a front wheel 11 and a rear wheel 12 are rotatably mounted. The rear wheel 12 can be driven in an electromotively assisted manner via a drive system with a drive train A. For this purpose, the drive train A comprises at least on electric drive motor in the form of an electric motor M. In this case, a drive torque generated by the electric motor M can-optionally in addition to a drive torque applied in a manner actuated by muscle power via a drive shaft/bottom bracket shaft T-be transmitted to the rear wheel 12 with the aid of a force transmission member, for example in the form of a chain or a belt. In this way, not only can a first drive torque be transmitted to the rear wheel 12, which torque is applied by a rider of the electric bicycle 1 via pedals connected to the bottom bracket shaft T, but rather the rear wheel 12 can also be driven via a second drive torque which is generated by the electric motor M.

In this case, a driving power applied by the electric motor M is specified via an electronic control unit SE of the drive unit A. Said electronic control unit SE specifies the driving power that is to be applied electromotively, for example depending on transmission stages selected on the user side, by means of which driving power a rider of the electric bicycle 1 is assisted when pushing the pedals. A corresponding transmission stage is then specified for example via an actuation unit 2. Said actuation unit 2, coupled to the control unit SE, is provided on handlebars of the electric bicycle 1 in the case of the electric bicycle 1 of FIG. 1, and is equipped with a display 20.

In order, if required, to adjust a transmission ratio and thus a ratio of a (motor) speed of the electric motor M to a speed of the rear wheel 12 to be driven, the electric bicycle 1 additionally comprises a gear-shifting device 14. Said gear-shifting device 14 can be controlled by the electronic control unit SE such that then, for example with the aid of a derailleur of the gear-shifting device 14 on a hub of the rear wheel 12, it is possible to change between different chainwheels for the chain 13. For a gear-shifting process triggered by the electronic control unit SE, for changing a transmission ratio, a brief forward movement of the chain 13 is caused, for which the electric motor M is operated at a defined target speed. In this case, a freewheel 15 in the region of the hub of the rear wheel 12 must be open, such that a drive force generated by the electric motor M is not transmitted to the rear wheel 12. In this way, an automatic gear-shifting process should also be carried out on the moving electric bicycle 1, if there is no pedal movement at the bottom bracket shaft T. Accordingly, no acceleration of the electric bicycle 1 may occur due to the gear-shifting process.

The proposed solution now allows a check of the plausibility and thus monitoring of the gear-shifting process, without additional sensors being required for this. For instance, the electronic control unit SE is coupled to a speed sensor 21 for the rear wheel 12, in order to conclude, on the basis of a wheel speed measured by the speed sensor 21 and the currently set transmission ratio between the speed of the electric motor M and a speed of the rear wheel 12, the need for a change in the transmission ratio and a target speed of the electric motor M provided for this, when performing a gear-shifting process, and to automatically trigger such a gear-shifting process. However, the gear-shifting process itself is monitored without using further sensor signals, in particular without using an additional speed sensor, in that during the gear-shifting process the electronic control unit SE monitors only the temporal development of a motor current I of the electric motor M and the temporal development of its speed n.

In the present case, for this purpose the electronic control unit SE implements a regulation for carrying out the gear-shifting process, by means of which the electric motor M is regulated to a constant target speed n_{Target} during the gear-shifting process. An underlying target current value for the motor current is furthermore limited to a comparatively small value as the maximum current value Iₘₐₓ (e.g. in the region of 2A). This current value is sufficient for adequately accelerating the electric motor M when the freewheel 15 is open. In the case of acceleration of the electric motor M, the regulator of the electronic control unit SE can consequently request, within limits, at most the maximum current value Iₘₐₓ for the motor current I (wherein in the case of acceleration, of course also a current below the maximum current value can be requested). If the freewheel 15 is closed during the gear-shifting process, the motor current I thus runs up to a current value below the maximum current value Iₘₐₓ and the electric motor M reaches the specified target speed n_{Target}.

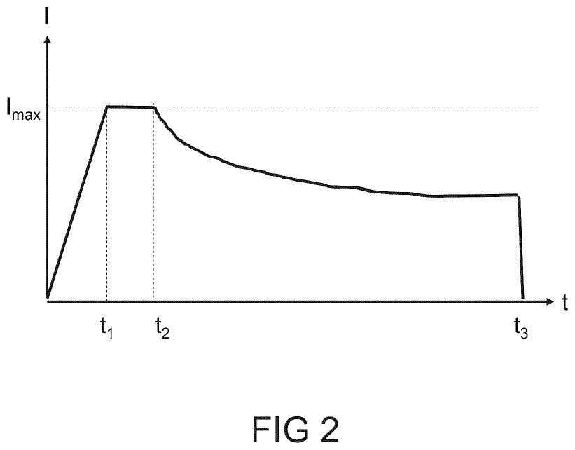

This is illustrated in more detail on the basis of the graph of FIG. 2. Here, the motor current I is plotted against time t. During the gear-shifting process, the motor current I increases in a first acceleration phase up to a timepoint t₁, up to the maximum current value Iₘₐₓ. If the electric motor M then rotates at the target speed n_{Target}, the motor current I drops again characteristically after a timepoint t₂, and remains significantly below the maximum current value Iₘₐₓ. The gear-shifting process is then completed by a timepoint t₃.

Consequently, during the gear-shifting process, the requested motor current I from the regulator of the electronic control unit SE must remain below the maximum current value Iₘₐₓ when the freewheel 15 is open and is consequently in an uncoupling state. If, in contrast, the freewheel 15 is closed, the requested motor current I increases again significantly in the direction of the maximum current value Iₘₐₓ, after the target speed has been achieved n_{Target}. Thus, a brief drop in the speed n can then also be identified after or before the timepoint t₁, upon closing of the freewheel 15. Typically, a drop in the speed n occurs before, because in the regulation process precisely a drop in the speed b results in an increase in the requested current. If the freewheel 15 already closes in the acceleration phase, i.e. before the timepoint t₁, a brief overshooting of the speed n of the electric motor M can be observed.

On the basis of the temporal curve of the motor current I of the electric motor M, optionally in combination with the temporal curve of the speed n of the electric motor M, it is thus possible to conclude, taking into account the regulation implemented in the electronic control unit SE, whether the freewheel 15 is open or closed.

However, since in the case of a closed freewheel 15 the electric motor M introduced a drive force on the rear wheel 12, although this should be excluded during the gear-shifting, the gear-shifting process is terminated in an electronically controlled manner upon detection of a closed freewheel 15. A termination criterion is consequently present here if a deviation, above a tolerance threshold taking into account measuring inaccuracies, from a stored reference value curve for the motor current and/or the motor speed is detected, which suggests closure of the freewheel 15. In response to such a termination criterion, the electronic control unit SE terminates the gear-shifting process and sharply reduces the speed of the electric motor M or even switches off the electric motor M. Furthermore, an incorrect speed measurement for the electric bicycle 1, or an incorrectly assumed gear ratio, can be signaled via the termination criterion, as a result of which the drive system can then be set into an error state.

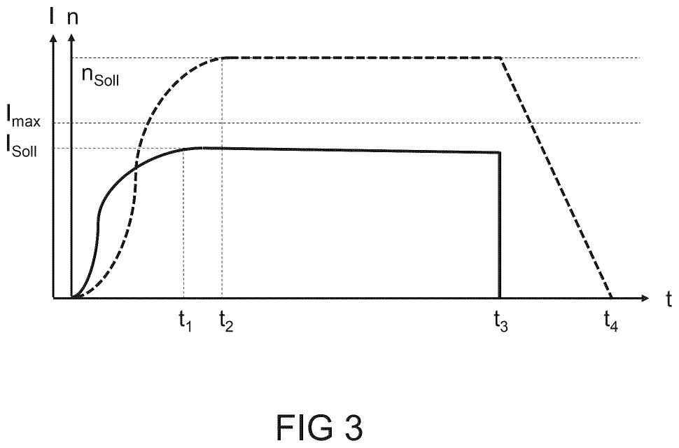

FIG. 3 illustrates characteristic curves of the motor current I and the speed n of the electric motor M in the case of a gear-shifting process, which can also be consulted by the electronic control unit SE for checking a correct procedure of the gear-shifting process. In this case, the speed n reaches the provided motor speed at a timepoint t₂, without the motor current I rising to the limit value or the maximum current value Iₘₐₓ. Rather, the motor current I increases only to a current target value I_{Target} that is below the maximum current value Iₘₐₓ. The requested motor current I then stays at this value, while the speed n remains at the target speed n_{Target}. If the gear-shifting process is completed, the motor current I falls, as does the speed n (compare timepoints t₃ and t₄ of FIG. 3). Thus, on the basis of the detected curves of the motor current I and the (motor) speed n of the electric motor M, a closed freewheel 15 can be indirectly concluded, which must in turn lead to a termination of the gear-shifting process.

In the case of a closed freewheel 15 during the acceleration of the electric motor M, or after completion of the acceleration phase, a characteristic deviation from the curves shown in FIG. 3 results. This then also includes for example the situation where the speed n cannot be increased up to the target speed n_{Target}, or the target speed n_{Target} is not achieved at all during a defined test period.

In a variant by way of example, in the case of the electric bicycle 1 for example, the electronic control unit SE calculates, in the case of stationary pedals and on the basis of a current gear-shifting transmission and the wheel speed measured by the speed sensor 21, a shifting pulse for the electronically controllable gear-shifting device 14. A shifting pulse is then implemented over a defined shifting time, for example 0.5 to 1.5 seconds, with the calculated and thus specified target speed n_{Target}, at a specified maximum current value Iₘₐₓ (for example 1A to 3A), via a speed regulator implemented in the electronic control unit SE. In this case, the speed of the electric motor M should be specified in a constant manner over the shifting time. In this case, the speed of the electric motor M can for example be configured such that a speed results on a rear wheel sprocket, based on the speed of the electric motor M, which corresponds to 50% of the rear wheel speed. Thus, the freewheel would be reliably uncoupled. During the shifting time and in the case of stationary pedals, active driving of the rear wheel 12 by the electric motor M is not permitted. By means of the proposed drive system it is now possible to detect that the freewheel 15 on the rear wheel 12 is and remains open during the gear-shifting process, and therefore no driving of the rear wheel 12 takes place during the gear-shifting process by the actuated electric motor M.

As explained above, in this case, in a first step during the acceleration phase the increase in the speed n up to the target speed n_{Target} with a minimum acceleration specified by the maximum current value Iₘₐₓ can be monitored. If an allowable acceleration is not reached, a closed freewheel 15 is concluded and the gear-shifting process is terminated. Thus, if the target speed n_{Target} is not achieved within a defined test period, it is assumed that the freewheel 15 is closed and therefore the gear-shifting process must be terminated.

If, in contrast, the speed regulator is set optimally, a motor current I below the permitted maximum current value Iₘₐₓ results, which then remains (virtually) constant or becomes smaller after reaching the target speed n_{Target}. If the motor current I increases further after the target speed n_{Target} is reached, in particular while the speed n reduces or remains constant, then the freewheel 15 has been closed and the gear-shifting process must be terminated.

Analogously, a closed freewheel 15 is concluded if the motor current I, after the target speed n_{Target} has been reached in the shifting phase (after the timepoint t₁ to the timepoint t₃) increases again in the direction of the maximum current value Iₘₐₓ.

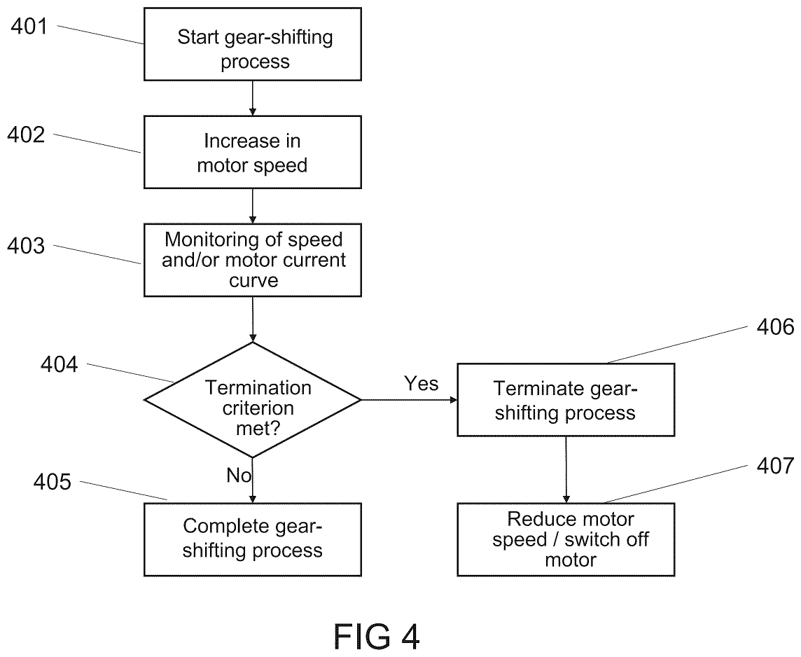

The flow diagram of FIG. 4 also illustrates the individual steps, mentioned above, of a corresponding operating method for the drive system. For instance, the gear-shifting process is therefore firstly started automatically, and thus triggered in an electronically controlled manner (step 401). In response to this, the regulation of the electronic control unit SE increases the motor speed n in the direction of a target speed value n_{Target} calculated for the gear-shifting process (step 402). In order to in this case monitor the state of the freewheel 15 and exclude the possibility of a drive force being transmitted to the rear wheel 12 by the actuation of the electric motor M, the speed and motor current curves for the electric motor M are monitored (step 403). In this case, based on stored reference curves the presence of a termination criterion is checked, which suggests a closed freewheel 15 (step 404). If, during the gear-shifting process, the presence of the termination criterion is not detected and therefore the freewheel 15 remains open, the gear-shifting process is completed properly (step 405). If, in contrast, the presence of the termination criterion is detected, the gear-shifting process is terminated in an electronically controlled manner (step 406). A corresponding termination then leads to a significant drop in the speed of the electric motor M, to a termination value or a switch-off of the electric motor M (step 407).

The proposed solution provides a possibility for determining, independently of a speed sensor, that a freewheel 15 is not closed and thus possibly a gear-shifting process must be terminated, which promotes the safety and reliability of the drive system, in particular in the case of a gear-shifting process being carried out, without additional costs for extended sensors having to be taken into account for this.

List of Reference Numerals
1 electric bicycle
10 frame
11 front wheel
12 rear wheel
13 force transmission member
14 gear-shifting device
15 freewheel
2 actuation unit
20 display
21 speed sensor
A drive train
M electric motor
SE electronic control unit
T bottom bracket shaft/drive shaft

1. The drive system for an electric bicycle, comprising
a drive train having at least one electric drive motor for applying a drive force for driving a wheel of the electric bicycle,
a gear-shifting device for changing a transmission ratio between the drive train and the wheel to be driven, and
an electronic control unit for controlling the at least one drive motor and the gear-shifting device,
wherein a freewheel is provided on the wheel to be driven, which freewheel, in a transmitting state, transmits a drive force generated by the at least one drive motor to the wheel, while in an uncoupling state of the freewheel the drive train is uncoupled from the wheel,
wherein the electronic control unit is configured for changing the transmission ratio to perform a gear-shifting process, in which a speed of the at least one drive motor is specified by the electronic control unit and the at least one drive motor is operable via the electronic control unit with a variable motor current, and
wherein the electronic control unit is configured to terminate a gear-shifting process when a termination criterion indicating the transmitting state of the freewheel is present and for detecting the presence of the termination criterion, to evaluate at least one of a curve of the speed and a curve of the motor current of the at least one drive motor.

2. The drive system according to claim 1, wherein the electronic control unit is configured to detect the presence of the termination criterion on the basis of at least one of the curve of the speed and the curve of the motor current of the at least one drive motor.

3. The drive system according to claim 2, wherein the electronic control unit is configured to detect the presence of the termination criterion solely on the basis of the curve of the motor current or in combination with the curve of the speed of the at least one drive motor.

4. The drive system according to claim 1, wherein for the uncoupling state of the freewheel during the gear-shifting process at least one reference speed curve for a temporal development of at least one of the speed and at least one reference current value curve for a temporal development of the motor current of the at least one drive motor are stored in a memory of the electronic control unit, and the electronic control unit is configured, in the case of a deviation, that exceeds a tolerance threshold, of one or more detected measured values relative to at least one of the reference speed curve and the reference current value curve, to detect the presence of the termination criterion.

5. The drive system according to claim 4, wherein for detecting whether the termination criterion is present the electronic control unit is configured for checking, during the gear-shifting process, whether
the speed increases with specification of a motor current increasing up to a maximum current value until a specified target speed is reached, and the motor current falls when the target speed is reached and maintained, or
the speed increases with specification of a motor current increasing up to a current target value, up to the target speed, and the target speed is maintained, retaining the current target value that is below the maximum current value.

6. The drive system according to claim 5, wherein the maximum current value is a limit value, which is stored in the electronic control unit, for the motor current, which limit value can be specified, by a regulation implemented using the control unit, as maximum value for the motor current for accelerating the at least one drive motor to the target speed.

7. The drive system according to claim 1, wherein for detecting whether the termination criterion is present the electronic control unit is configured for checking, during the gear-shifting process, whether the speed of the at least one drive motor reaches a specified target speed within a predefined test period.

8. The drive system according to claim 1, wherein the electronic control unit is configured, in the case of a termination of the gear-shifting process, to reduce the speed of the at least one drive motor to a termination value or to deactivate or actuate the at least one drive motor for changing to an error state.

9. The drive system according to claim 1, wherein the electronic control unit is configured to determine a target speed, to which the at least one drive motor is to be accelerated for the gear-shifting process, on the basis of a sensor signal representative for a current travel speed of the electric bicycle and a currently set transmission ratio.

10. An electric bicycle comprising a drive system according to claim 1.

11. A method for operating a drive system on an electric bicycle, wherein the drive system comprises:
a drive train having at least one electric drive motor for applying a drive force for driving a wheel of the electric bicycle, and
a gear-shifting device for changing a transmission ratio between the drive train and the wheel to be driven,
wherein a freewheel is provided on the wheel to be driven, which freewheel, in a transmitting state, transmits a drive force generated by the at least one drive motor to the wheel, while in an uncoupling state of the freewheel the drive train is uncoupled from the wheel,
wherein for changing the transmission ratio a gear-shifting process is performed in which, in an electronically controlled manner, a speed of the at least one drive motor is specified and the at least one drive motor is operated with a variable motor current, and
wherein a gear-shifting process is terminated when a termination criterion indicating the transmitting state of the freewheel is present, wherein for detecting the presence of the termination criterion at least one of a curve of the speed and a curve of the motor current of the at least one drive motor is evaluated.
